(19) United States
(12) Patent Application Publication
(10) Pub. No.: US 2014/0140845 A1
(43) Pub. Date: May 22, 2014

(54) AN AXIAL TURBINE FOR A TIDAL POWER PLANT AND A METHOD FOR THE ASSEMBLY THEREOF

(71) Applicant: VOITH PATENT GMBH, (US)

(72) Inventors: Patrick Hennes, Herbrechtingen (DE); Christian Muller, Heidenheim (DE); Alexander Sauer, Heidenheim (DE)

(73) Assignee: VOITH PATENT GMBH, Heidenheim (DE)

(21) Appl. No.: 13/761,611

(22) Filed: Feb. 7, 2013

Related U.S. Application Data
(63) Continuation of application No. PCT/EP2012/000882, filed on Mar. 1, 2012.

(30) Foreign Application Priority Data
Mar. 10, 2011 (DE) 10 2011 013 546.4

(51) Int. Cl. F03B 3/12; B21D 53/78

(52) U.S. Cl. CPC F03B 3/128; B21D 53/78
USPC 416/2; 29/889.3

(57) ABSTRACT

An axial turbine for a tidal power plant, including a hub with a rotor blade holder and a rotor blade with a blade fastening section having a longitudinal axis including a fastening stub, a radial fixing and an anti-rotation element. The fastening stub includes a contact surface supported against a complementarily shaped fixing surface on the rotor blade holder whose envelope is rotationally symmetrical to the longitudinal axis. The radial fixing secures the rotor blade fastening section against a withdrawal movement relative to the rotor blade holder in the direction of the longitudinal axis. The anti-rotation element is connected with a complementarily shaped rotational stop on the rotor blade holder with an effective area of the anti-rotation element being a component of the blade fastening section arranged separate from the radial fixing, and the radial fixing comprises fastening means that has a predetermined breaking point of the blade fastening section.

### CROSS REFERENCE TO RELATED APPLICATIONS

This is a continuation of PCT application No. PCT/EP2012/000882, entitled “AN AXIAL TURBINE FOR A TIDAL POWER PLANT AND A METHOD FOR THE ASSEMBLY THEREOF”, filed Mar. 1, 2012, which is incorporated herein by reference.

### BACKGROUND OF THE INVENTION

1. Field of the Invention

The invention relates to an axial turbine for a tidal power plant and especially the blade fastening for rotor blades of an axial turbine which are linked in a torsionally rigid manner, and to a method for its mounting.

2. Description of the Related Art

Tidal power plants using a horizontal rotor configuration are known, and include an axial turbine whose rotational axis is aligned parallel to the inflow. Axial turbines of tidal power plants include rotor blades which are linked in a torsionally rigid manner in order to provide the sturdiest possible configuration in combination with low maintenance. For this purpose, either the entire axial turbine will be made to move about the vertical axis of the installation for adjustment to a cyclically changing direction of flow, or the axial turbine has rotor blades that can be accessed by the inflow in a bidirectional manner. There is no possibility for the latter type of installation, in particular, to change the characteristic curve of the axial turbine by turning the rotor blades out of the flow during the occurrence of a peak load in order to reduce the load on the rotor. Consequently, the load-absorbing components of the axial turbine, and the rotor blade connections in particular, need to be provided with a large safety margin. When large-size axial turbines are used for efficiently utilizing slow water flows, this will lead to holding structures for the rotor blades that require a high level of material input.

A cylindrically shaped fixing section with a fastening flange is typically provided adjacent to the profiled blade sections of the rotor blades for the purpose of fixing the blade for the axial turbine of a tidal power plant. Reference is hereby made, by way of example, to GB 2467226 A, US 2008/020922 A1, U.S. Pat. No. 5,173,023 and GB 502409. Forces and torques from different directions are introduced to the effective areas of the fastening flange and the screw crown for currently known blade fastenings. Transverse forces and bending loads and torques about the longitudinal axis of the blade fastening will result especially from the shearing forces, in addition to the forces used for propulsion tangentially to the hub.

### SUMMARY OF THE INVENTION

The present invention is based on the object of providing an axial turbine for a tidal power plant with improved blade fastening for rotor blades linked to a hub and especially fixed in a torsionally rigid manner. In this process, a simplification in construction and production of the rotor blade connection shall be enabled in combination with a simultaneously secure configuration of the installation. Furthermore, the axial turbine includes standardized rotor blades which can be adjusted to different installation locations. Furthermore, a simplified mounting method for such an axial turbine will be provided.

The inventors have recognized that for the purpose of connecting the rotor blades, the occurring forces and torques for different effective directions need to be intercepted by securing components allocated depending on the direction. This allows the possibility of providing a rotor blade holder with a defined predetermined breaking point which is substantially associated with a selected direction of load. A fastening component which fulfils a specific supporting function can be an element which can be adjusted specifically to a location in order to adapt a standardized rotor blade to a selected installation location.

For a preferred embodiment of the invention, an axial turbine of a tidal power plant includes a hub with at least one rotor blade holder in which the blade fastening section of a rotor blade has been introduced. The blade fastening section is assigned to a longitudinal axis which is determined by the effective area of a fastening stub. This effective area is the contact surface of the fastening stub, which rests for support against a complementarily shaped holding surface on the rotor blade holder. It comprises an enveloping surface which is rotationally symmetrical to the longitudinal axis. In an especially preferred way, the effective areas of the holding surface are rotationally symmetrical themselves.

The fastening stub can be introduced into the rotor blade holder by an insertion movement in the direction of the longitudinal axis. This is achieved in the simplest way by a conically tapering fastening stub. As a result of the mutual support of the contact surface on the fastening stub and the complementarily shaped holding surface, transverse forces laterally to the longitudinal axis and therefore the relevant bending loads on the blade fastening will be intercepted in the mounting position.

The blade fastening section of the rotor blade comprises a radial fixing as a further component, the radial fixing secures the blade fastening section against a withdrawal movement relative to the rotor blade holder in the direction of the longitudinal axis. A withdrawal movement shall be understood as being a movement in the longitudinal direction, which leads the blade fastening section out of the rotor blade holder. If a radial beam geometry is provided for the axial turbine, the withdrawal movement corresponds to a displacement of the rotor blade radially to the outside.

Furthermore, the blade fastening section comprises an anti-rotation element which enters into operative connection with a complementarily shaped rotational stop on the rotor blade holder. The effective area of the anti-rotation element represents a component which is arranged separately from the radial fixing. As a result of this arrangement on the blade fastening section, it is ensured that the support of a torque about the longitudinal axis and an action of force parallel to the longitudinal axis are intercepted by different components of the rotor blade holder. For an alternative embodiment there are two or more anti-rotation elements and a respective number of corresponding rotational stops. Embodiments are especially preferred for which the anti-rotation elements are arranged in such a way that only one installation position is possible for the rotor blade in order to enable the exclusion of mounting errors.

For an advantageous further development of the invention, the radial fixing comprises a predetermined breaking point which is loaded in operation of the axial turbine substantially in the direction of the longitudinal axis of the blade fastening section. In the simplest of cases they will be fastening means such as threaded bolts in particular, on which a tensile load will act parallel to the longitudinal axis during rapid running of the axial turbine. When exceeding a predetermined load threshold, these fastening means can break so that the radial fixing will lose its securing function and the centrifugal forces can pull the rotor blade in the direction of the longitudinal axis out of the rotor blade holder. Such an overload-induced blade detachment reduces the likelihood of serious damage to the entire installation. Consequently, the blade fastening and the further load-carrying structures of the drive train can be provided with a more slender configuration. Furthermore, a rotor blade severed by overloading may be retrieved and mounted again.

For a further development of the invention, the separate support of the blade torque about the longitudinal axis allows the use of components adapted specifically to an installation. For this purpose, either the anti-rotation element on the blade fastening section or the rotational stop on the blade holder or both components can be adjusted to the respective conditions at the site. The starting point is a standardized rotor blade which is fastened with a selected installation angle to the hub of the axial turbine depending on the load histogram present at the installation location. For this purpose, the radial fixing is arranged in such a way that for an intermediate mounting step a free rotation is enabled in a predetermined angular interval for the fastening stub introduced into the rotor blade holder. Preferably, a rotational angle interval <10° about a standard position is used, and especially preferably <5°.

For the purpose of selecting a specific rotational angle, the adjustment of the anti-rotation element and/or the rotational stop occurs in a next step, with the elements preferably being arranged as separately exchangeable components. Accordingly, either a location-specific anti-rotation element and/or a respectively adjusted rotational stop can be used for fixing a selected installation angle, or an adjusting apparatus is provided which is preferably assigned to the anti-rotation element and/or the rotational stop.

There can be further coupling elements on the blade fastening section without abandoning the directionally separated supporting function of the fastening stub, the radial fixing and the anti-rotation element in accordance with the invention. The anti-rotation element is attached to a contact surface of a flange part for an advantageous embodiment. This provides additional securing and insertion limitation for the insertion of the blade fastening section into the rotor blade holder. The flange part is advantageously in a torsionally rigid and preferably materially connected connection with the fastening stub, so that the contact surface on the flange part is guided against a flange support surface during the insertion of the blade fastening section into the rotor blade holder, which flange support surface is assigned to the rotor blade holder. The flange support surface or the flange part itself comprises oblong holes or an opening in the form of an annular segment through which the fastening means of the radial fixing will pass, so that a certain amount of twisting of the radial fixing relative to the anti-rotation element will remain possible for an intermediate mounting step.

An embodiment can further be considered for which the anti-rotation element is arranged on the fastening stub. A fixing of the anti-rotation element on the jacket surface of the fastening stub is possible. A further alternative embodiment is obtained for a fastening stub which is arranged as a hollow body, with an attachment of the anti-rotation element to an inside wall being possible in this case. Furthermore, the fastening stub on the jacket surface or an inside wall is provided for an embodiment with projections and setbacks according to a toothing arrangement. In this case, the contact surface on the rotor blade holder must be provided with a respective complementary configuration. For this embodiment, merely an envelope of the contact surface is provided for supporting lateral forces on the fastening stub in a rotationally symmetrical way with respect to the longitudinal axis, whereas the projections and setbacks are assigned to the effective area of the anti-rotation element for supporting the blade torque about the longitudinal axis. In an especially preferred way, a separate arrangement of the fastening stub and the anti-rotation element is provided, as well as a configuration for which the anti-rotation element on the blade fastening section will only be in alignment in a specific angular position with the associated rotational stop on the rotor blade holder, so that error-free mounting of the rotor blades is ensured.

Furthermore, a method for mounting an axial turbine in accordance with the invention includes the insertion of the fastening stub into the rotor blade holder and a rotation of the blade fastening section about its longitudinal axis until the anti-rotation element can enter into operative connection with the complementarily shaped rotational stop on the rotor blade holder. In this process, at the endpoint of the movement of the fastening stub in the direction of the longitudinal axis the preferably rotationally symmetrically arranged contact surface of the fastening stub rests on a complementarily shaped fixing surface of the rotor blade holder. The radial fixing can be mounted in a subsequent step which secures the rotor blade fastening section against a withdrawal movement relative to the rotor blade holder in the direction of the longitudinal axis. In this process, an effective area of the anti-rotation element supports the blade torque about the longitudinal axis in the mounted state. At least this effective area forms a component which is separate from the radial fixing. In a further method step, this allows a separate exchange or setting of the anti-rotation element and/or the element complementary thereto (i.e. the rotational stop) on the rotor blade holder. A standardized rotor blade can consequently be used, the installation angle of which can be adjusted in a manner specific to the installation.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a perspective view of a rotor blade with a blade fastening section arranged in accordance with an embodiment of the present invention;

FIG. 2 shows a perspective view of a rotor blade holder arranged in accordance with the present invention on a hub of an axial turbine;

FIG. 3 shows a further embodiment for a rotor blade with a blade fastening section in accordance with the present invention;

FIG. 4 shows an alternative embodiment for a rotor blade holder in accordance with the present invention on the hub in a perspective view;

FIG. 5 shows a further embodiment for a rotor blade holder in accordance with the present invention in a representation according to FIG. 4;

FIG. 6 shows the overall view of an axial turbine in a perspective view; and

FIG. 7 shows a top view of a rotor blade of FIG. 6 in the direction of the longitudinal axis of the blade fastening section.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

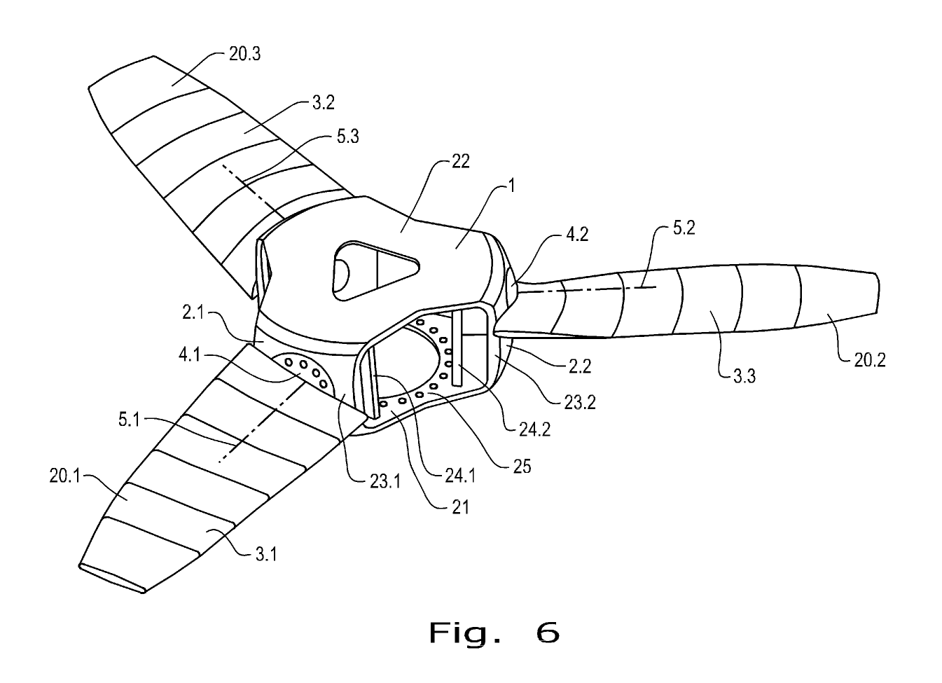

Referring now to the drawings, FIG. 6 shows a schematically simplified, perspective view of an axial turbine for a tidal power plant. The embodiment includes three rotor blades 3.1, 3.2, 3.3 which are fastened to a hub 1 in a torsionally rigid manner. The hub is preferably arranged as a box-like body with a breakthrough, which includes two parallel surface elements with the shaft-side hub part 21 and the cap-side hub part 22, which surface elements are axially spaced with respect to the drive shaft of the axial turbine (not shown). They are in connection in the region of the rotor blade holder 2.1, 2.2 by means of a first connecting web 23.1, 23.2 and a second connecting web 24.1, 24.2. An integral configuration of hub 1, in the form of a cast part, for example, is also possible. Furthermore, openings in hub 1 are further provided in the intermediate regions of the blades, so that an access is provided to the interior region of hub 1 as well as a light structure.

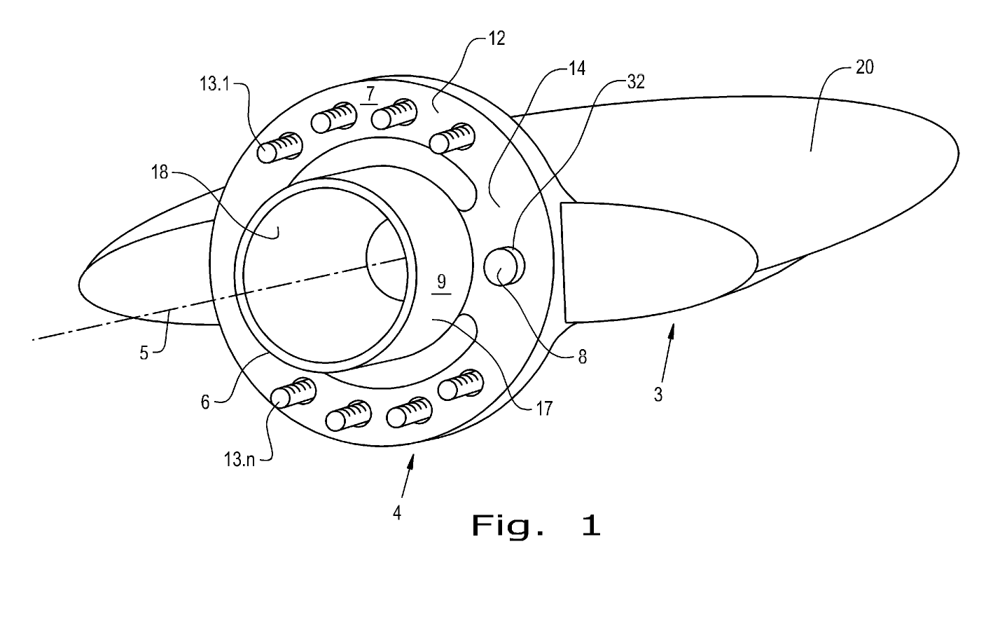

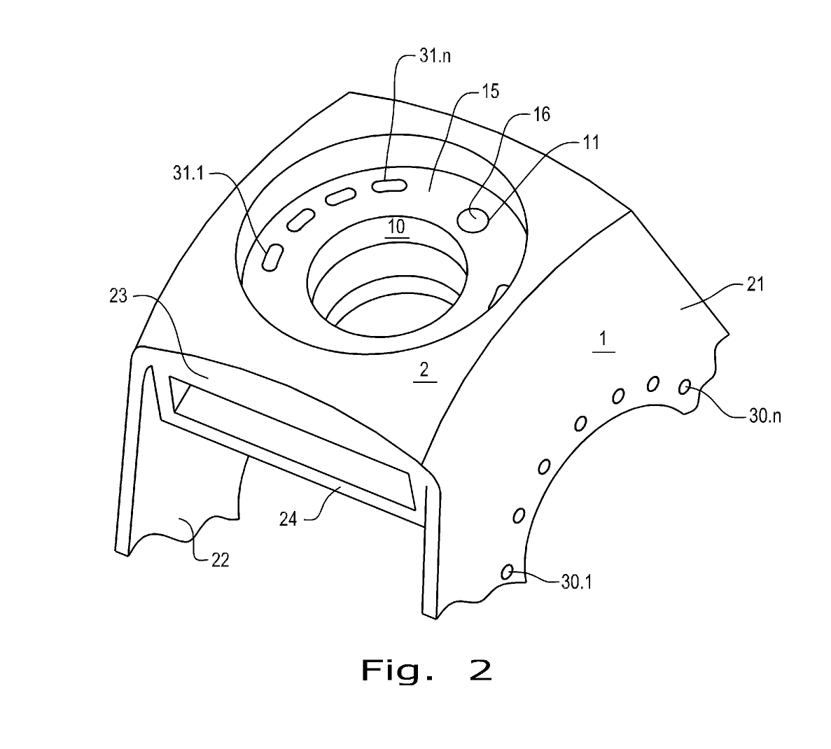

Rotor blades 3.1, 3.2, 3.3 respectively include a profiled blade section 20.1, 20.2, 20.3 and a blade fastening section 4.1, 4.2, 4.3. Longitudinal axes 5.1, 5.2, 5.3 are assigned to the blade fastening sections 4.1, 4.2, 4.3, the determination of which is shown in FIG. 1. It schematically shows a simplified perspective view of a blade fastening section 4 for a rotor blade 3 which includes a fastening stub 6, a radial fixing 7 and an anti-rotation element 8. Blade fastening stub 6 is arranged as a hollow, rotationally symmetrical component. It has a jacket surface 17 and an inside wall 18, with jacket surface 17 being chosen as contact surface 9 for the illustrated embodiment, which jacket surface is used for the support on an associated, complementarily shaped fixing surface 10 of rotor blade holder 2, as shown in FIG. 2. The determination of longitudinal axis 5 of the blade fastening section 4 follows from contact surface 9 of fastening stub 6, with longitudinal axis 5 forming the axis to which contact surface 9 is rotationally symmetrical.

Fastening stub 6, which is preferably in connection with the inner supporting structure of profiled blade section 20, is introduced into the circular openings in first connecting web 23 and second connecting web 24 of rotor blade holder 2 as shown in FIG. 2. When reaching the end position, contact surface 9 on fastening stub 6 rests on the complementarily shaped fixing surface 10 and is used for absorbing forces transverse to the longitudinal axis and bending loads.

Blade fastening section 4 further includes a flange part 12 which is materially connected with fastening stub 6 and includes a contact surface 14 which rests in the mounting position on a flange support surface 15 on rotor blade holder 2. A cylindrically arranged anti-rotation element 8 is arranged on contact surface 14, which anti-rotation element 8 engages in the mounting position in a complementarily arranged borehole 16 in the flange support surface 15. In this process, borehole 16 forms rotational stop 11 on rotor blade holder 2, which rotational stop is complementarily shaped in relation to anti-rotation element 8. Anti-rotation element 8 and rotational stop 11 merely determine a potential installation position of blade fastening section 4 in rotor blade holder 2. Furthermore, anti-rotation element 8 supports the blade torque about longitudinal axis 5 which occurs during the operation of the axial turbine. The effective area 32 on anti-rotation element 8 and the wall of borehole 16 for rotational stop 11 are adjusted to one another in a respectively custom-tailored manner. In this respect, a conical progression of the surface can be provided on the blade holder for simplifying the insertion for anti-rotation element 8 and fastening stub 6, or for the components that are complementary thereto.

Further embodiments of anti-rotation element 8 and rotational stop 11 (not shown in closer detail) are possible. In this respect, a peg-shaped structure can especially be provided in rotor blade holder 2 which engages into a recess on blade fastening section 4. Furthermore, more than one anti-rotation element 8 and a plurality of corresponding rotational stops 11 can be provided.

The last remaining degree of freedom of blade fastening section 4 relative to rotor blade holder 2 is secured by radial fixing 7, which includes, for the illustrated embodiment, several fastening means 13.1, . . . , 13.n in form of threaded bolts. They are guided through boreholes in flange part 12 and reach through openings in rotor blade holder 2 which are arranged as oblong holes 31.1 . . . 31.n. Accordingly, fastening means 13.1, . . . , 13.n of radial fixing 7 are substantially subjected to tension, wherein a clearly defined overload threshold can be determined above which the fastening means 13.1, . . . , 13.n will break with a high amount of probability, so that the entire rotor blade 3 will be ejected from hub 1 in the longitudinal direction by action of centrifugal force. Accordingly, for the illustrated advantageous embodiment radial fixing 7 forms a defined predetermined breaking point for the rotor blade linkage, which is not exposed to any complex undefined action of force.

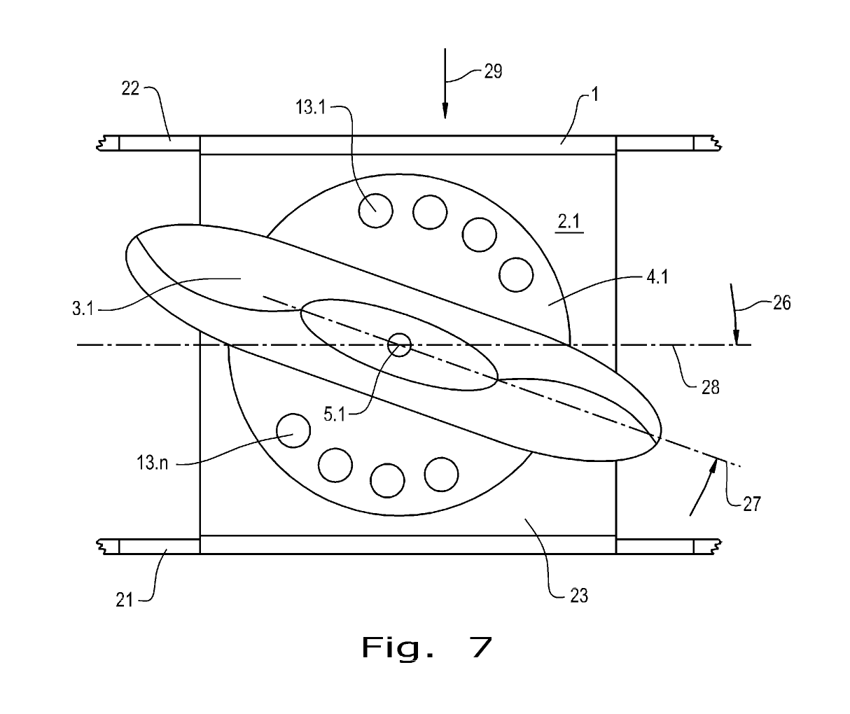

The functional allocation for fastening stub 6, radial fixing 7 and anti-rotation element 8 further allows a simplified, installation-specific adjustment of an installation angle for a rotor blade 3.1. Reference in this respect is made to FIG. 7, which shows, in a schematically simplified view, a rotor blade 3.1 with the associated blade fastening section 4.1 in the direction of longitudinal axis 5.1. The mounting state is illustrated for which blade fastening section 4.1 is introduced into rotor blade holder 2.1 on hub 1.

FIG. 7 illustrates an installation angle 26 between a transverse axis 27 of blade 3.1 and a hub plane 28. The transverse axis 27 of blade 3.1 is defined by the chord line of a selected profile section. Hub plane 28 is defined by the piercing points of the longitudinal axes 5.1, 5.2, 5.3 of rotor blades 3.1, 3.2, 3.3 with respect to a selected plane of the associated rotor blade holders 2.1, 2.2, 2.3. In this process, hub plane 28 extends perpendicularly to inflow direction 29 of the tidal flow for an optimal orientation of the installation.

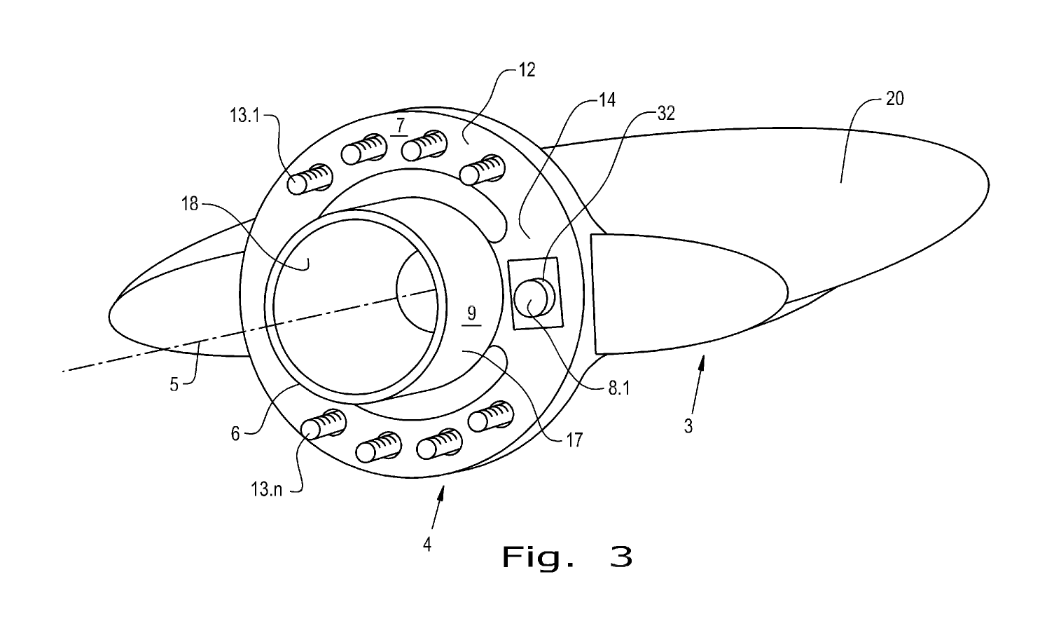

For location adjustment of installation angle 26, the position of anti-rotation element 8 is set relative to the further components of blade fastening section 4 and therefore to the profiled blade sections 20. For a first embodiment shown in FIG. 3, anti-rotation element 8.1 is arranged as a separately exchangeable component which is accommodated in a recess of contact surface 14 on flange part 12.

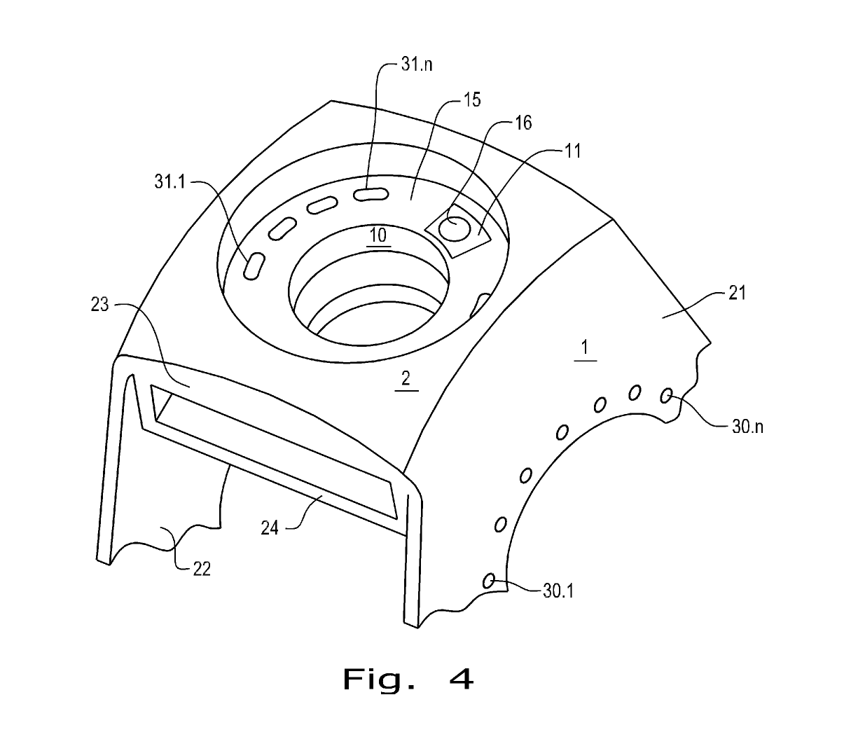

An alternative embodiment is obtained from FIG. 4, which shows a separately exchangeable rotational stop 11 which is fitted into a recess on flange support surface 15 of rotor blade holder 2. Borehole 16 can be determined in a predetermined angular range which is limited by the dimensioning of separate rotational stop 11. The measures shown in FIGS. 3 and 4 are preferably combined with one another in order to achieve the most variable installation angle 26.

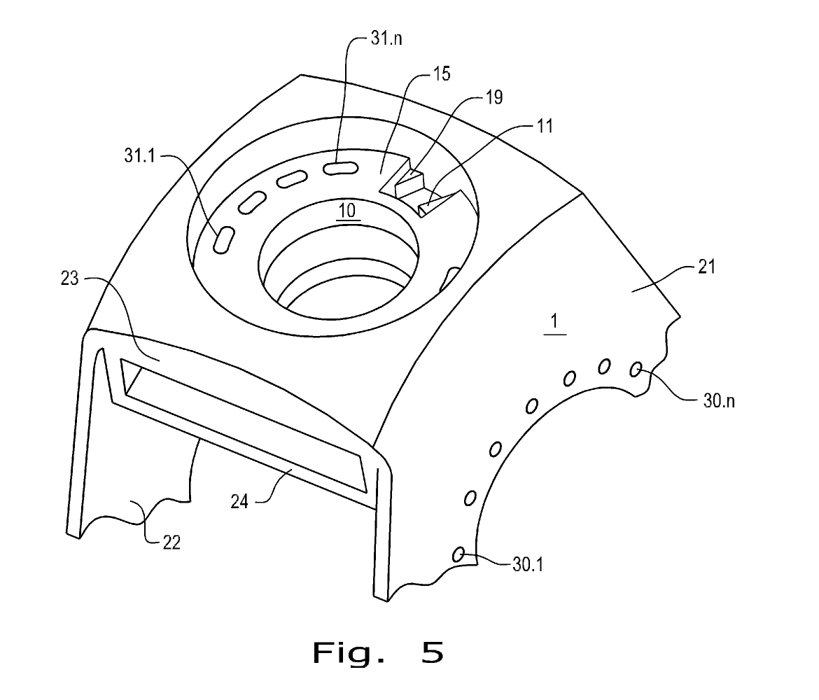

FIG. 5 shows a further development of the embodiment for installation-specific adjustment, for which an adjusting apparatus 19 is provided on rotational stop 11 of the rotor blade holder 2. A corresponding development, which is not shown in closer detail, provides that anti-rotation element 8.1 on blade fastening section 4 is provided with an adjusting apparatus. Adjusting apparatus 19 as shown in FIG. 5 includes a paired arrangement of wedge-like components which are radially movable relative to the longitudinal axis and which vary the position of the effective area of rotational stop 11 in the circumferential direction relative to the longitudinal axis. Accordingly, an adjustment of installation angle 26 of the associated rotor blade is performed by adjusting apparatus 19.

Further embodiments of the invention are possible within the framework of the following claims. The blade fastening in accordance with the invention can be connected with a pitch angle adjusting mechanism, so that the aforementioned torsionally rigid linkage occurs on a rotor blade holder 2 which is rotatable relative to hub 1.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE NUMERALS

1 Hub
2, 2.1, 2.2 Rotor blade holder
3, 3.1, 3.2, 3.3 Rotor blade
4, 4.1, 4.2 Blade fastening section
5, 5.1, 5.2, 5.3 Longitudinal axis
6 Fastening stub
7 Radial fixing
8, 8.1 Anti-rotation element
9 Contact surface
10 Fixing surface
11 Rotational stop
12 Flange part
13.1, . . . , 13.n Fastening means
14 Contact surface
15 Flange support surface
16 Borehole
17 Jacket surface
18 Inside wall
19 Adjusting apparatus
20, 20.1, 20.2, 20.3 Profiled blade section
21 Hub part on the shaft side
22 Hub part on the cap side
23, 23.1, 23.2 First connecting web
24, 24.1, 24.2 Second connecting web
25 Intermediate blade region
26 Installation angle
27 Transverse axis of the blade
28 Hub plane
29 Inflow direction
30.1, . . . , 30.n Borehole
31.1, . . . , 31.n Oblong hole
32 Effective area

What is claimed is:

1. An axial turbine for a tidal power plant, comprising:
a hub (1) with at least one rotor blade holder (2, 2.1, 2.2, 2.3);
at least one rotor blade (3, 3.1, 3.2, 3.3) with a blade fastening section (4) having a longitudinal axis (5, 5.1, 5.2, 5.3), said blade fastening section including:
a fastening stub (6);
a radial fixing (7); and
an anti-rotation element (8), said fastening stub (6) having a contact surface (9) configured for support against a complementarily shaped fixing surface (10) on said rotor blade holder (2, 2.1, 2.2, 2.3), said rotor blade holder having an envelope that is rotationally symmetrical to the longitudinal axis (5, 5.1, 5.2, 5.3), said radial fixing (7) securing said rotor blade fastening section (4) against a withdrawal movement relative to said rotor blade holder (2, 2.1, 2.2, 2.3) in a direction of the longitudinal axis (5, 5.1, 5.2, 5.3), said anti-rotation element (8) is operatively connected with a complementarily shaped rotational stop (11) on said rotor blade holder (2, 2.1, 2.2, 2.3) configured for supporting a blade torque about the longitudinal axis (5, 5.1, 5.2, 5.3), said anti-rotation element (8) having an effective area (32) that is a component of said blade fastening section (4) which is arranged separate from said radial fixing (7), said radial fixing (7) includes fastening means (13.1, . . . , 13.n) which are configured as a predetermined breaking point of said blade fastening section (4).

2. The axial turbine of claim 1, wherein at least one of said anti-rotation element (8) and said rotational stop (11) are components adjusted specifically to the installation.

3. The axial turbine of claim 1, wherein at least one of said anti-rotation element (8) and said rotational stop (11) are arranged as separately exchangeable components.

4. The axial turbine of claim 1, wherein at least one of said anti-rotation element (8) and said rotational stop (11) are associated with an adjusting apparatus (19).

5. The axial turbine of claim 1, wherein said blade fastening section (4) includes a flange part (12) on which said anti-rotation element (8) is arranged.

6. The axial turbine of claim 5, wherein said rotor blade holder (2, 2.1, 2.2, 2.3) includes a flange support surface (15), said fastening means (13.1, . . . , 13.n) being guided by oblong holes (31.1, . . . , 31.n) on at least one of said flange part (12) and said flange support surface (15).

7. The axial turbine of claim 5, wherein said fastening stub (6) is connected to said flange part (12).

8. The axial turbine of claim 1, wherein said rotor blade holder (2, 2.1, 2.2, 2.3) includes a flange support area (15) in which said rotational stop (11) is accommodated.

9. A method for mounting an axial turbine for a tidal power plant, comprising the steps of:
guiding a fastening stub (6) of a rotor blade (3, 3.1, 3.2, 3.3) into a complementarily shaped fixing surface (10) on a rotor blade holder (2, 2.1, 2.2, 2.3) of a hub (1), said fastening stub (6) having a contact surface (9) whose envelope is rotationally symmetrical to a longitudinal axis (5, 5.1, 5.2, 5.3);
introducing said contact surface (9) into said rotor blade holder (2, 2.1, 2.2, 2.3);
twisting said rotor blade (3, 3.1, 3.2, 3.3) about the longitudinal axis (5, 5.1, 5.2, 5.3) to such an extent until an anti-rotation element (8) is in alignment with a complementarily shaped rotational stop (11) on said rotor blade holder (2, 2.1, 2.2, 2.3);
entering said anti-rotation element (8) of said rotor blade (3, 3.1, 3.2, 3.3) into operative connection with said complementarily shaped rotational stop (11), said rotor blade (3, 3.1, 3.2, 3.3) having a radial fixing (7) and a rotor blade fastening section (4); and
attaching said radial fixing (7) to secure said rotor blade fastening section (4) against a withdrawal movement relative to said rotor blade holder (2, 2.1, 2.2, 2.3) in the direction of said longitudinal axis (5, 5.1, 5.2, 5.3), said anti-rotation element (8) having an effective area (32) which forms a component of said blade fastening section (4) separate from said radial fixing (7), said anti-rotation element (8) supporting the blade torque about the longitudinal axis (5, 5.1, 5.2, 5.3), said radial fixing (7) including fastening means (13.1, . . . , 13.n) which are used as a predetermined breaking point of said blade fastening section (4).

10. The method of claim 9, wherein said anti-rotation element (8) and said rotational stop (11) are adjusted in an installation-specific manner.
